(19) United States
(12) Patent Application Publication
(10) Pub. No.: US 2007/0007686 A1
(43) Pub. Date: Jan. 11, 2007

(54) MULTI-PURPOSE WIDE PROTECTIVE SPECTRUM WOOD PRESERVATIVE SYSTEM AND METHOD OF USE

(76) Inventor: Josh Reid, Valdosta, GA (US)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 11/428,719

(22) Filed: Jul. 5, 2006

Related U.S. Application Data
(60) Provisional application No. 60/696,716, filed on Jul. 5, 2005.

(51) Int. Cl. B27N 3/00; C09D 5/14; B29C 59/00

(52) U.S. Cl. 264/109; 106/15.05; 264/129

(57) ABSTRACT

A preservative chemical to create a water-tolerant, full coverage, formaldehyde encasing, fire resistant preserved solid sawn wood products and composite boards as well as methods of manufacturing same.

### REFERENCE TO A RELATED APPLICATION

This application claims the benefit of my earlier provisional application Ser. No. 60/696,716, filed Jul. 5, 2005, which is relied on and incorproated herein by reference.

### FIELD OF THE INVENTION

The present invention relates to preservative chemical formulations and methods of using the same in the manufacture of water tolerant, full coverage, formaldehyde encasing, fire resistant preserved composite boards and solid sawn wood products.

### BACKGROUND

Many states have banned chemicals such as creosote which are considered hazardous and are either completely forbidden or diluted to such an extent as to impact the ability to adequately preserve wood. Therefore, the industry has continued its search for suitable preservative materials for use on sawn wood products as well as for incorporation into composite board products.

Each year in the United States, over a hundred billion board feet of wood products are produced. Included are natural wood as well as man-made, manufactured wood products such as plywood, oriented strand board (OSB), particle board (PB), medium density fiber board (MDF) as well as many other products made from wood chips, wood pulp and/or wood fiber.

The use of wood for furniture, housing and other industrial purposes is so widespread that the treatment of wood is performed by many companies in many locations. Typically, large quantities of wood are treated for commercial, industrial and residential use including fence posts, decking, landscape timbers, railroad ties, utility poles and the like.

It is the current practice in the wood treating industry for wood to be dried prior to any preservation treatment process. Wet or green wood is less desirable because a preservation treatment chemical is less efficiently absorbed and cannot be effectively distributed throughout the wood to achieve the intended protective preservation result. Any suitable drying technique can be used as is well known in the art.

Conventional preserved wood products use either toxic chemicals for their preservation or use application methods that result in insufficient protection. Most solid sawn treated wood products use either CCA (chromated copper arsenate) or creasote. Creasote is highly flammable and is not environmentally friendly while CCA has extreme health risks associated with its use. With composite boards in the typical case of zinc borate use of a water insoluble form creates several problems. Additional equipment is often needed for application of the zinc borate. Also additional costs may be incurred in order to create an adequate product due to requiring additional resin and, therefore, additional cook time to provide adequate binding. Using a powdered form of preservative may result in incomplete dispersion. Without adequate dispersion of the preservative a buildup occurs in certain areas of the composite board leading to a product lacking in full coverage. If this occurs, the preservative is grouped in aggregations in some areas of the board while leaving other areas of the composite board unprotected. Other methods require the preservative to be applied directly to the wood cellouse. This creates a problem by coating the wood and inhibiting the penetration of the resin and wax which must take place in order to manufacture a quality product. Additionally, no multipurpose wood preservative exists to decrease formaldehyde emissions or cover such a wide area of protection. Thus, a need exists for preserved, formaldehyde encasing, fire resistant, water-tolerant, solid sawn wood products and composite boards with full coverage using readily available ingredients and equipment.

### SUMMARY OF THE INVENTION

The present invention provides a system for the preservation and protection of solid sawn wood products and articles as well as composite boards.

In one aspect of the invention, there is a method for the production of a preserved wood-containing composite product comprising forming chips from a wood source by conventional means, drying the chips of wood to obtain at least partially dried wood chips; treating said wood chips with a suitable binder resin, preservative chemical and wax. The binder resin must be capable of binding the wood chips into a composite product, preferably selected from the group consisting of urea-formaldehyde and phenol-formaldehyde. The liquid preservative chemical comprises an alkali metal silicate of the formula M₂O.nSiO₂, where M is an alkali metal. Optionally, a boron component can also be added. The treatment of the at least partially dried wood chips can be carried out by premixing binder resin and wax together and applying the resulting mixture to the wood pieces to at least partially coat said wood chips with the binder resin and was. Preferably, the binder and the wax are applied to the wood chips separately and sequentially. Most preferably, the resin, wax and preservative chemical are applied to the wood chips in that order. Thus, the preferred method of the invention is carried out by blending the dry wood chips coated with the binder resin and wax with the preservative to obtain wood chips coated with all components to obtain a reaction mixture; optionally adding more wax; shaping the reaction mixture into a dedsired form such as a board, beam, plank or the like; and heating or baking the reaction mixture to harden the binder resin to form the desired shaped wood composition product.

In another aspect of the present invention, there is provided a method of preserving sawn wood comprising impregnating a sawn wood product such as a post, plank, stud, panel or the like with a preservative composition comprising an alkali metal silicate having the formula M₂O.n SiO₂ wherein M is an alkali metal and n represents the number of moles of silica for each mole of alkali metal, a source of boron and a natural or synthetic petroleum based wax being in either a slack wax or wax emulsion form combined together in sufficient amounts to achieve the desired measure of protection and preservation.

In a still further aspect of the present invention, there is provided a method of making a wood composite material having improved scavenger properties for volatile organic compounds comprising mixing together pieces of wood with binder resin and wax to at least partially coat the pieces of wood with the binder and wax; applying to the pieces of wood at least partially coated with the polymeric binder and wax, a preservative composition comprising an alkali metal silicate having the formula M₂O.n SiO₂ where M is an alkali metal and n is the number of moles of silica for each mole of alkali metal; optionally, adding to the preservative composition a source of boron, orienting the pieces of wood and shaping the pieces of wood coated with the binder, wax and preservative to form a shaped article; and heating the shaped article to harden the binder resin to form the wood composite material. This method results in a wood product having markedly reduced tendency for release of volatile organic compounds.

The present invention also provides for a silicate based preservative which includes a source of boron, such as a borate compound, which preservative has a pH of at least about 11.5, a low viscosity enabling easy application and impregnation of wood, and where the preservative comprises of at least 30% by volume of silica in the form of an alkali metal silicate, with an additional biocide which is a boron containing entity. The invention calls for the solid sawn wood product to be pressure treated with the preservative chemical alone or with the preservative chemical blended or manufactured with a suitable wax.

In another aspect, the invention calls for the manufacture of composite board where first the wood chips are dried and then transferred to a blender where a spin dish atomizer or air atomizer is used to apply resin, wax, and the preservative, preferably in that order. Additionally, a wax composition may be blended or manufactured with the preservative to create additional water repellency over and above the wax that has already been applied to the wood itself, provided that the wax composition is compatible with the preservative and remains stable after mixing. The resin used for forming the composite board can be any suitable thermosetting resin, such as urea-formaldehyde, phenol-formaldehyde and the like, all of which are well known in the art.

The present invention provides improved products made of wood, timber, lumber, and similar celluloric plant derived construction and building materials such as composite boards, other materials of cellulosic origin, other materials of organic origin and other materials containing constituents including wood, lumber, similar plant derived, cellulosic and/or organic materials.

The treatment as described herein can be carried out by various means including pressure treating, soaking, spraying, painting, washing, dipping, rubbing, mixing, blending, infusion and the like.

### DETAILED DESCRIPTION OF INVENTION

The present invention relates both to preservative chemical compositions and techniques necessary to impart preservation characteristics to solid sawn wood products and composite boards.

The silicate preservative chemical of the present invention is non-toxic and covers a wide spectrum of uses that are advantageous to the consumer and manufacturer. A positive benefit obtained thereby is that the silicate allows for a lower borate concentration in the wood product to be effective against pests such as termites than would otherwise be needed in the absence of the silicate component.

Silicon based wood treatments have been used for many years. However, such methods have not been altogether successful in achieving the desired results.

The alkali metal silicate used in the present invention is generally uniformly distributed; that is, dissolved or dispersed in water. The alkali metal silicates are well-known chemical compounds and can be represented by the formula M₂O.nSiO₂, wherein “M” represents the alkali metal, preferably sodium or potassium, and “n” represents the number of moles of silica for each mole of M₂O. The usual commercially available form of these sodium silicate dispersions is typically known as water glass and that material is the preferred material for use as described herein. Crystalline silica or quartz can also be used for purposes of the present invention.

Borates have long been known to kill pests through ingestation. The addition of the silicate is believed to create micro scratches on the exoskeleton of the pest allowing the borates to be effective by contact alone without the need for ingestation. The silicate additionally allows for more borate retention after leaching and acts as a free formaldehyde scavenger, as well as adding fire resistance properties to the wood product. The addition of the wax to the preservative formulation provides additional water repellency over and above wax previously applied to the wood fiber and provides to the manufacturer of composite boards an all in one chemical to contribute protection and water repellency with or without the use of standard wax alone.

Without being bound by any theory, it is believed that the silicate component of the present invention acts on the exoskeleton of insects. This is the cuticle or outer shell which has an outer waxy coating. The thin shell and waxy coating is the primary protection of the insect to ensure maintenance of its vital body fluids. The silicate is believed to impact the exoskeleton and possibly cause openings or cracks therein which will permit the biocidal ingredient present in the formulations of the present invention to impact the sensitive portions of the insect body and, therefore, lead to the extermination of the insect. The amount of silicate can range from about 30% to 55% by weight of the preservative formulation.

The boron compounds suitable for purposes of the present invention should have a content of combined boron equivalent of at least 35% by weight B₂O₃. Representative of such sources of boron are boric oxide, boric acid, borax which is sodium tetraboratedecahydrate, borax pentahydrate, and hydroborax, various potassium borates and various calcium borates.

The source of boron is preferably present in an amount of about 1 to 15% by weight of the preservative. The preservative can additionally contain at least one of a silicon emulsion as a surfactant, or other known surfactants, an additional biocide, and an alkali metal lignosulfonate.

The wax component of the present invention can be any suitable wax or paraffin-based composition including, but not limited, to paraffin wax dispersed in mineral oil, natural waxes as well as synthetic waxes. When added to the preservative formulation of the present invention, the wax can be present in an amount of 90%. Generally, a wax emulision is used comprising the wax, water and a surface active agent to make an emulsion.

When ready to apply to the wood surface, the preservative has a solids content of about 18 to 22% by weight, but can be applied up to 70%.

The process is a new and novel method of application of the preservation formulation using current manufacturing parameters and facilities and using a liquid form of the preservative instead of the standard powder. The benefits of the application method of this invention are numerous. First, it allows the resin and the wax to fully coat the wood chips thereby granting adequate bonding. By using an air atomizer or spin disk atomizer well known in the art, the method of the invention generates complete and even distribution of the preservation formulation over each individual chip contained in the composite board. The use of a liquid preservative insures adequate coverage and eliminates the unprotected areas that result from using a powder form. Next, the addition of the preservative not only has preservative qualities itself but acts as a further protectant by being present in the matrix of the chemical portion of the composite board by absorbing moisture before it has a chance to permeate the wood fiber itself. Prior art has shown that mold, decay, and pests need a high moisture content in wood to exist and thrive. Another benefit is that the preservative chemical acts as a scavenger of the free formaldehyde that exists in phenol-formaldehyde and urea-formaldehyde resins commonly used in the industry. This greatly reduces formaldehyde emissions that are irritating to mammals when the final product is used in the construction of furniture, offices, homes, schools, etc.

Additional biocides can be applied to the wood chips prior to shaping into the desired form. Any biocide that has been shown to inhibit or kill microorganisms and fungi can be used. Examples are silver nitrate, ethylene glycol, arsenic, alcohols, chlorine, other halogens, etc. Such substances are well known in the art. Additional biocides can also be included into the preservative for treating sawn wood products.

In carrying out one aspect of the process of the invention in connection with the preparation of OSB (oriented strand board), a blender is used which is similar to a large dryer containing banks of air atomizers. The wood flakes or chips are charged into the blender and are tumbled in the blender while the thermosetting resins such as urea formaldehyde or a phenol-formaldehyde resin is sprayed in. This stage is intended to coat the wood flakes or chips with the binder resin. The wax component which is typically an emulsion in water is then sprayed on the resin coated flakes and, thereafter, the treatment chemical of silicate and, optionally, boron containing compound are applied. The blended mixture is then sent to a conventional orienter which orients the wood flakes or chips, as is known in the art, to produce the desired oriented strand board. The chips after blending are placed in a bin and from there they flow down and out to orienting means which can be a series of rotating metal discs that introduce random orientation to the chips as they fall through the discs onto a moving conveyor. Such equipment is well known in the art. Using this technique, it is also possible to produce multi-laminated products by laminating together a plurality of oriented strand boards prepared as described herein, with the option of adding additional fire protection to the finished products by spraying or coating a high solid solution of the preservative.

When making a multi-laminate product, two or more blenders can be used to create a core and two outer layers, each one of the outer layers is then applied to one side of the core. If different resins are used, different cook times will apply. Typically, a 50% solids preservative solution content is necessary to form the core whereas a 20% solid preservative solution content is used for the surface layers. This is due to the excess moisture being added to the wood but if the preservative is used in conjunction with a wax this is not necessary.

Prior to charging the chips or flakes into the blender, they are typically dried to a low moisture content of approximately 6 to 7% although this is not critical. The chips or flakes are typically of the dimension of one to two inches in width and three to four inches in length. Prior to heating to thermoset the binder resins, the rectangular-shaped chips and flakes are oriented so as to have approximately 50% by volume of the chips oriented in the direction of one axis of the final product and the other 50% by volume of the chips oriented 90 degrees or perpendicular to the other 50% of the chips.

The layers are then pressed together using conventional equipment and conventional cook times and pressure conditions. The resulting laminated layers can then be cut to size utilizing no additional adhesive. There is typically a few minutes lag time between the layer formation and applying pressure; for example, from three to seven minutes.

The wax component used in the preferred aspect of the invention is either a lignin-based wax “brown wax” or a “white wax” made using non-ionic surfactants. Soap based “white wax” is generally not preferred due to the fact that the preservative can cause shearing or caking in these products unless a suitable stabilizer is used. If a soap based “white wax” is still desired by the manufacturer due to lower cost it is advised to employ an inline mixer to blend the preservative solution and wax emulsion upon application.

It is preferred to use a wax emulsion and for that reason, a surface active agent is preferably employed. It has been found that when making the layers, it is preferred to form a 21.7% solids composition containing chemicals, flakes and resin. In the final product, the ingredients are expressed in percent by volume. For example, in the final composite product, the wax is present in an amount of up to 50% by volume of the wood composite product.

The preservative formulation prior to incorporation into the product has a pH of typically about 7.5 to 12.5, preferably about 11. The alkalinity can be adjusted by the addition of an alkali such as sodium hydroxide, potassium hydroxide or suitable agent such as diethanolamine, triethanolamine, anunonia, etc. which facilitates the dissolution of the borate component.

In the foregoing example, the weight ratio of wax to preservative chemicals is about 50:50. For additional fire protection, it is recommended to form a preservative coating on the surface of the wood composite product which functions as an overcoat for fire protection and, typically, this overcoat contains 52% solids.

The wood flakes that are employed to form the preferred product of the invention are typically one to two inches wide and three to four inches long. They are approximately rectangular in shape.

When forming a medium density fiberboard (MDF), these products are typically not used outdoors but are primarily used for indoor applications such as furniture. In that function, there is a significant scavenger problem and there exists the need to trap volatile organic compounds. The composition of the present invention has been found to be particularly useful for that purpose where the silicate functions as a scavenger for volatile organic compounds. It is also preferred to use defoaming agents and, for this purpose, a silicon emulsion can be used.

In accordance with the invention, the combination of the silicate and borate component accomplishes a synergistic effect because it enables the use of less of the boron compound for biocidal purposes.

### EXAMPLE 1

The treatment chemical of this example is made by adding to a quantity of water, 30 wt % to 55 wt % sodium silicate, 1 wt % to 15 wt % sodium teraborate decahydrate, 0.001 wt % to 5 wt % silicon emulsion, 0.001 wt % to 0.01 wt % of a suitable biocide such as parahydroxybenzoic acid methylester. Additionally sodium hydroxide can be added to increase the pH to a desired range of 10.0 to 11.5. This will form a chemical solution of approximately 21.7% solids. It is advantageous to increase the amount of solids in the solution to reduce the water content added to manufactured boards as well as spray on applications.

The addition of the wax formulation can be added in amounts in a range of 0.005% to 75% by volume and provides additional water repellancy over and above wax previously applied to the wood fiber. Additionally, up to 50 wt % of boron can be added to the wax alone to protect the manufactured board product from termites alone if no additional protection provided by the preservative is desired.

Further variations and modifications of the foregoing will be apparent to those skilled in the art and are intended to be encompassed by the claims appended hereto.

1. A method for the production of a preserved wood containing composite product comprising:
drying pieces of wood to obtain at least partially dried wood pieces;
treating said pieces of wood with a thermosetting binder resin;
treating said pieces of wood with a wax;
blending the wood pieces and binder resin to at least partially coat said wood pieces;
applying a liquid preservative to said wood pieces coated with binder resin and wax, said liquid preservative comprising an alkali metal silicate of the formula M₂O.nSiO₂ where M is an alkali metal, and, optionally, a boron component;
blending the wood pieces coated with the binder resin and wax with the preservative to obtain wood pieces coated with all components to obtain a reaction mixture;
optionally applying more wax to said wood pieces;
shaping the reaction mixture into a desired form; and
heating the reaction mixture to harden the binder resin to form the desired wood composite product.

2. The method according to claim 1, wherein the boron component is a member selected from the group consisting of boric oxide, boric acid, borax, borax pentahydrate, hydrous borax and potassium borate.

3. The method according to claim 1, wherein the silicate is sodium silicate or potassium silicate.

4. The method according to claim 1, wherein the wax is a natural or synthetic wax.

5. The method according to claim 1,wherein the amount of silicate in the preservative is at least 30% by weight of the preservative.

6. The method according to claim 1, wherein the wood is in the form of rectangular chips which are oriented prior to heating the reaction mixture to obtain an oriented strand board.

7. The method according to claim 7, wherein the chips are one to two inches in width and three to four inches in length.

8. The method according to claim 1, wherein the preservative has a solids content of about 18 to 22% by weight.

9. The method according to claim 1, wherein the amount of silicate ranges from 30 to 55% by weight of the preservative,

10. The method according to claim 1, wherein the boron component is present in an amount of about 1 to 15% by weight of the preservative.

11. The method according to claim 1, wherein the preservative additionally contains at least one of a silicon emulsion, a biocide, and an alkali metal lignosulfonate.

12. The method according to claim 1, wherein the thermosetting resin is selected from the group consisting of urea-formaldehyde and phenol-formaldehyde.

13. A method of preserving sawn wood comprising:
impregnating a sawn wood product with a preservative composition comprising an alkali metal silicate having the formula M₂O.nSiO₂ wherein M is an alkali metal and n represents the number of moles of silica for each mole of alkali metal, a source of boron and a natural or synthetic wax combined in a sufficient amount to achieve the desired measure of protection and preservation.

14. A method of making a wood composite material having improved scavenger properties for volatile organic compounds comprising:
mixing together pieces of wood, binder resin and wax to at least partially coat the pieces of wood with the binder and wax;
applying to the pieces of wood coated with the binder and wax, a preservative composition comprising an alkali metal silicate having the formula M₂O.nSiO₂ where M is an alkali metal and n is the number of moles of silica for each mole of alkali metal;
orienting the pieces of wood and shaping the pieces of wood coated with the binder, wax and preservative to form a shaped article; and
heating the shaped article to harden the binder resin to form the wood composite material.

15. The method according to claim 14, wherein the binder resin is urea formaldehyde or phenol-formaldehyde.

16. The method according to claim 14, wherein the silicate is sodium silicate or potassium silicate.

17. The method according to claim 14, wherein the pieces of wood are wood chips having a dimension of one to two inches in width and three to four inches in length.

18. The method according to claim 14, wherein the preservative composition has a pH of 7.5 to 12.5.

19. The method according to claim 14, wherein the wax is present in an amount of up to 50% by volume of the wood composite material.

20. The method according to claim 14, wherein the preservative composition contains up to 50% of the silicate by weight.

21. A preservative composition comprising:
an alkali metal silicate having the formula M₂O.nSiO₂ wherein M is an alkali metal and n is the number of moles of silica for each mole of alkali metal,
a boron compound which is a source of boron,
optionally a silicon emulsifier, a biocide or alkali metal lignosulfonate.
